(19) United States
(12) Patent Application Publication
(10) Pub. No.: US 2008/0306188 A1
(43) Pub. Date: Dec. 11, 2008

(54) Novel UV inhibitors and stabilizers, derived from a biomass feedstock source, for thermoplastic and thermosetting resins

(75) Inventors: Richard William Tock, Humboldt, IA (US); Daniel W. A'Hern, Kemah, TX (US)

Correspondence Address: ELIZABETH R. HALL, 1722 MARYLAND STREET, HOUSTON, TX, 77006, US

(73) Assignee: Impact Composite Technology, Ltd., Houston, TX (US)

(21) Appl. No.: 11/983,157

(22) Filed: Nov. 7, 2007

Related U.S. Application Data
(60) Provisional application No. 60/933,364, filed on Jun. 6, 2007.

(51) Int. Cl. B27K 5/00

(52) U.S. Cl. 524/15

(57) ABSTRACT

The invention relates in general to biomass derived compositions and methods of applying such biomass derived compositions to protect polymeric materials from degradation due to ultraviolet (“UV”) radiation or light and weathering. More particularly, the invention relates to the use of cotton gin waste to protect polymeric composites from degradation due to UV radiation and weathering. One embodiment of the present invention includes dusting the surface of liquid polymeric materials with a cotton gin waste powder to protect the polymeric material from UV radiation induced damage.

### CROSS REFERENCE TO RELATED APPLICATIONS

The present application, pursuant to 35 U.S.C. 111(b), claims the benefit of the filing date of provisional application Ser. No. 60/933,364 filed Jun. 6, 2007, entitled “Compositions and Methods for Protecting of Polyester Composites from Ultraviolet Damage.”

### FIELD OF THE INVENTION

The present invention relates in general to biomass derived compositions and methods of applying such biomass derived compositions to protect polymeric materials from degradation due to ultraviolet (“UV”) radiation or light and weathering. More particularly, the invention relates to the use of cotton gin waste to protect polymeric composites from degradation due to UV radiation and weathering.

### DESCRIPTION OF THE RELATED ART

Ultraviolet (“UV”) light or radiation is part of the solar radiation emissions. The wavelengths that make up UV radiation are shorter than the wavelengths that define visible light and, hence, are undetectable by human vision. Scientists have subdivided the wavelengths that define UV radiation into several categories as follows: UVA includes wavelengths ranging from 320-400 nanometers; UVB includes wavelengths ranging from 280-320 nanometers; and UVC includes wavelengths less than 280 nanometers.

Ultraviolet radiation can interact with a variety of materials to produce deleterious effects. Fortunately, a large amount of the ultraviolet radiation originating from the sun is removed by the earth's atmosphere so that the energy content decreases in intensity from 400 nanometers to practically zero at 290 nanometers. Although about 99% of the UV radiation that reaches the earth's surface is UVA, the low levels of the lower UV wavelengths also contribute to the rapid destruction of many substances such as plastic or polymeric materials.

Most polymeric materials that are exposed to the UV radiation in sunlight are slowly damaged by the irreversible degradation of their molecular structure. Covalent molecular bonds that are common in plastics, such as carbon-carbon or carbon-hydrogen bonds, are broken by UV radiation. Because of the preponderance of carbon-hydrogen bonds found in plastics, carbon-hydrogen bonds are frequently broken and a free radical site left in the polymeric chain. Such free radical sites can attack the polymeric chain to further disrupt the polymeric chain and weaken or embrittle the plastic.

One way to diminish the effect of UV radiation on polymeric materials is to add UV stabilizers to plastics. UV stabilizers typically include additives which absorb and/or react with UV radiation, but do not form free radicals. Such UV absorbers are predominantly represented by substituted phenolic structures. Many UV stabilizers also include antioxidants that react with and neutralize the free radicals formed from exposure to UV radiation. Unfortunately, the vast majority of UV stabilizers, including UV absorbers and free radical scavengers, are derived from non-renewable petrochemical feed stocks.

Thus, there is a need to find ways of protecting polymeric compositions that are derived from natural renewable resources.

### SUMMARY OF THE INVENTION

The invention relates in general to biomass derived compositions and methods of applying such biomass derived compositions to protect polymeric materials from degradation due to ultraviolet (“UV”) radiation or light and weathering. More particularly, the invention relates to the use of cotton gin waste to protect polymeric composites from degradation due to UV radiation and weathering.

One embodiment of the present invention includes dusting the surface of liquid polymeric materials with a cotton gin waste powder to protect the polymeric material from UV radiation induced damage.

The foregoing has outlined rather broadly several aspects of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed might be readily utilized as a basis for modifying or redesigning the structures for carrying out the same purposes as the invention. It should be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a UV spectrum of an ethanolic extract of a cotton gin waste (Renfil 16/80);

FIG. 2 is a UV spectrum of an ethanolic extract of a cotton gin waste comminuted to pass though an 80 mesh screen;

FIG. 3 is a UV spectrum of an ethanolic extract of a wood flour; and

FIG. 4 is a UV spectrum of an ethanolic extract of a nut hull flour.

### DESCRIPTION OF THE PREFERRED EMBODIMENTS

Most polymeric materials exposed to significant amounts of sunlight are slowly damaged by the irreversible degradation of their molecular structure. Covalent molecular bonds, such as carbon-carbon or carbon-hydrogen bonds, are broken by UV radiation and additional damage arises due to the formation of free radicals.

Since the vast majority of the UV radiation impinging on the earth's surface is UVA, the photon energy of UVA radiation has been estimated and compared to the covalent bond energies commonly found in plastics. Radiation having a wavelength of 400 nanometers will have a photon energy of 83 kcal/mol, while radiation having a wavelength of 320 nanometers will have a photon energy of 89.32 kcal/mol. Common covalent bonds in plastics are carbon-carbon bonds having an average bond energy of 83 kcal/mol, carbon-hydrogen bonds having an average bond energy of 99 kcal/mol, carbon-oxygen bonds having an average bond energy of 84 kcal/mol, and carbon-nitrogen bonds having an average bond energy of 70 kcal/mol.

This information explains why carbon black is a good UV stabilizer. The abundance of carbon-carbon bonds having an average bond energy of 83 kcal/mol in carbon black, suggest that carbon black can absorb energy equivalent to radiation having wavelengths in the midrange of UVA radiation.

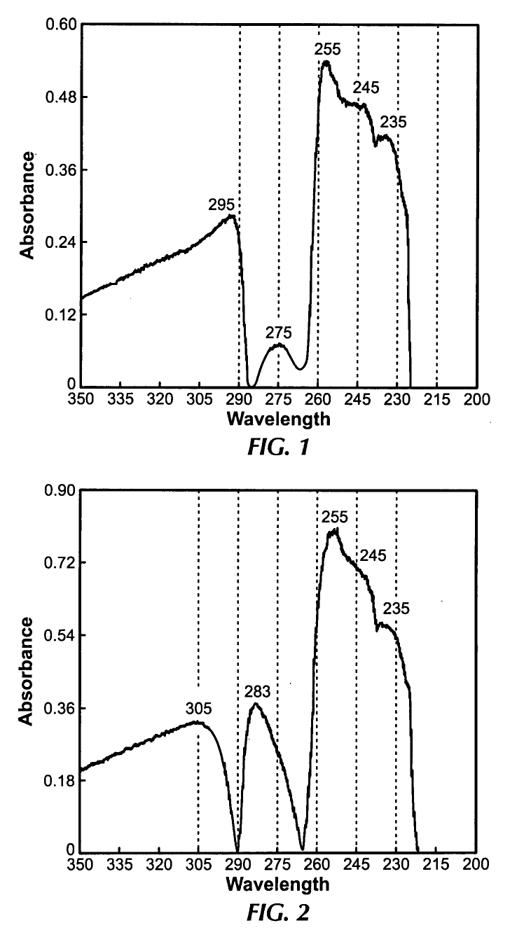

A search was undertaken to identify the chemical constituents, extractable from renewable nontoxic resources, which act as UV stabilizers and antioxidants. Initially, several natural biomass materials were extracted with ethanol and the ethanol extracts of the samples were analyzed for the presence of UV absorbing compounds. Five grams of each biomass sample were stirred in 100 ml of ethanol at room temperature for 30 minutes. The UV absorbance spectra of ethanolic extracts of cotton gin waste, wood flour, and nut hull flour are seen in FIGS. 1-4. All four samples had continuous UV absorption loci across the wavelength spectra. However, the wavelength at which a UV absorption maxima or a shoulder occurred signified a change in the absorptive behavior of the sample at that wavelength. The specific UV absorption maxima and shoulders for each sample are set out below.

Two samples of cotton gin waste screened to different sizes were extracted with ethanol. The UV absorption spectrum of the ethanol extract of the larger particles of gin waste (commercially available as Renfil 16/30 from Impact Composite Technology, Ltd., Houston, Tex.) is seen in FIG. 1. Three UV absorbing peaks were observed having UV maxima at 295, 275 and 255 nanometers. The 255 nanometer peak had two shoulders at 245 and 235 nanometers.

The UV absorption spectrum of the ethanol extract of the smaller particles of gin waste, comminuted by passage through an 80 mesh screen (commercially available as Renfil 80 from Impact Composite Technology, Ltd., Houston, Tex.), is seen in FIG. 2. Three UV absorbing peaks were observed having UV maxima at 305, 283 and 255 nanometers. The 255 nanometer peak had two shoulders at 245 and 235 nanometers.

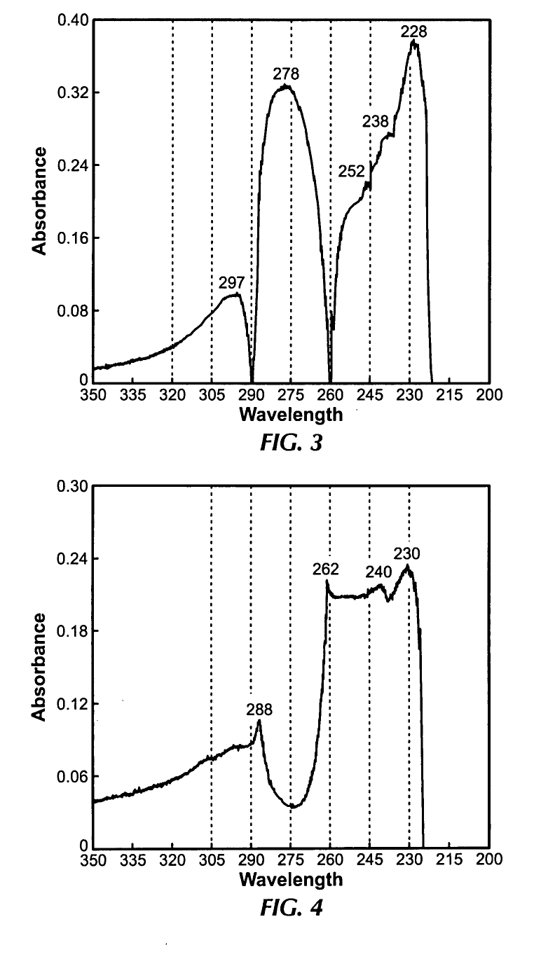

The UV absorption spectrum of the ethanol extract of a medium grade sample of wood flour is seen in FIG. 3. Three UV absorbing peaks were observed having UV maxima at 297, 278 and 228 nanometers. The 228 nanometer peak had two shoulders at 252 and 238 nanometers.

The UV absorption spectrum of the ethanol extract of the nut hull flour is seen in FIG. 4. Two UV absorbing peaks were observed having UV maxima at 288 and 230 nanometers. The 230 nanometer peak had two shoulders at 262 and 240 nanometers.

Since all the samples tested contain UV absorbing compounds, the comminuted gin waste was further investigated for its use as a UV protector. Ethanol extracted approximately 10% of the original mass of the gin waste. A number of semi-volatile organic compounds were detected in the ethanol extract. Twelve of the semi-volatile organic compounds were seen at detectable levels and were chemically identified. Table 1 gives the molecular structure, the name of the twelve components and

TABLE 1

| Component | Ethanol | | |
|---|---|---|---|
| Identified in | Extraction | Concentration | |
| EtOH Extract | Data | (mg/L) | Weight % |
| Phenol | 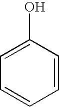 | 1.08 | 7.38 |
| Benzyl Alcohol | 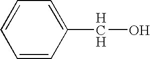 | 4.34 | 29.65 |
| 4-Methyl Phenyl | 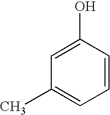 | 1.07 | 7.31 |
| Naphthalene | 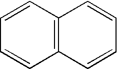 | 1.70 | 11.61 |
| Diethylphthalate | 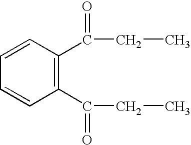 | 0.551 | 3.76 |
| Diphenylhydrazine | 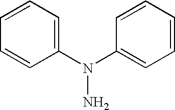 | 0.534 | 3.65 |
| Anthracene | 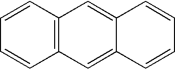 | 0.984 | 6.72 |
| Phenanthrene | 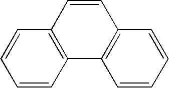 | 1.01 | 6.90 |
| Di-n-butylphthalate | 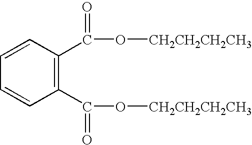 | 0.659 | 4.50 |
| Butylbenzlphthalate | 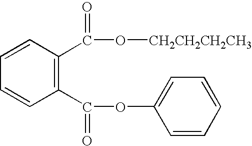 | 0.964 | 6.59 |
| Di-n-octylphthalate | 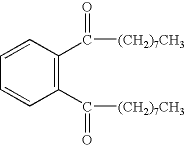 | 0.444 | 3.03 |
| Isophorone | 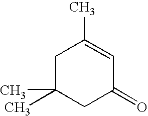 | 1.30 | $\frac{8.88}{99.98}$ |

their concentration in the ethanol extract. Their concentration ranged from a low concentration of 0.4 mg/L for di-n-octylphthalate to a high concentration of 4.34 mg/L for benzyl alcohol. It is noted that about 20% of these compounds are derivatives of phthalic acid. Several of these compounds are known to be UV absorbers such as ethyl methanesulfonate, nitrobenzene, 2 nitroaniline, and diphenylhydrazine.

The twelve identified compounds included a number of potential antioxidants, as well as UV absorbers. Antioxidants identified in the ethanol extract were phenol, benzyl alcohol, 4-methylphenol, 2,4 dimethylphenol, diethylphthalate, di-n-butylphthlate, butylbenzenephthalate, bis(ethylhexyl)phthalate, and di-n-octylphthalate.

Gin waste fibers are known to inhibit free radical polymerization reactions, such as the polymerization of styrene. Thus, when gin waste fibers are used in the production of plastics more peroxide initiator is added to start and sustain the polymerization process. As free radical scavengers, the phenols and quinones represent excellent long term effective UV inhibitors. These compounds can deactivate the free radicals produced from UV radiation and thereby prevent the free radicals from reacting with and weakening the polymer structure.

It should be noted that the penetrating depth of the UV wavelengths that pass through the earth's atmosphere is limited. Most of the UV damage to plastic occurs within a few millimeters of the surface exposed to direct sunlight. Thus, the application of UV absorbers and antioxidants to the external surface of polymeric materials is effective in at least partially protecting those materials from the damaging effects of UV radiation (hereinafter, referred to as “UV protected”).

The cotton gin waste was found to be a great UV stabilizer for at least three reasons: (1) the ability to absorb UV radiation, (2) the presence of antioxidants, and (3) the ability to apply the gin waste onto surfaces that will be exposed to direct sunlight. Furthermore, applying a powdered cotton gin waste to the surface of liquefied polymeric materials imparts a natural wood like texture to the surface of the finished polymeric product.

Polymeric materials, such as styrene and polyester composites, are used in a variety of products that are directly exposed to UV radiation and are known to be susceptible to radiation damage. Such products include automotive and marine structural components, home and garden furniture and structural elements, farm implements, industrial storage tanks, and numerous other products. Both thermoplastic and thermoset plastics are used in the construction of these products.

Thermoplastic Products

A plastic in which the polymer molecule is not crosslinked is designated thermoplastic. Since the molecules are not connected by crosslinks, it allows the molecules to soften, melt, or flow when heat is applied. Thus, melting the plastic and allowing it to cool within a mold will form the finished product. Thermoplastic composites are typically compounded by melt blending the resin with additives and reinforcement fibers. Generally, the resin, additive(s), and reinforcement fiber(s) are blended as they pass through an extruder. Upon exiting the extruder in a strand, the blended mixture is cooled and cut into pellets for subsequent molding. Thermoplastic processing via injection, compression, extrusion, pulltrusion, melt coating, rotorotational molding, and other such methods are contemplated by the use of the term “molded” herein.

A number of resins are used in thermoplastics, a few of the more common ones are polypropylene, polyethylene, polystyrene, thermoplastic polyester, and polyvinyl chloride. The reinforcement fiber reinforces the plastic matrix like steel bars reinforce concrete used in foundations. The type and configuration of the reinforcement fiber is selected, along with the type of additives added to the matrix, to specifically produce the desired characteristics for the thermoplastic product being made. Although, glass is probably the most common reinforcement fiber used, cellulose fibers and other materials are also used to reinforce the matrix.

Natural biomass materials (such as cotton gin waste, wood flour, and nut hull flour) are added to thermoplastic products to at least partially protect them against UV radiation damage. The natural biomass materials act as reinforcement fibers for the plastic matrix, as well as providing at least partial UV protection for the thermoplastic.

A preferred embodiment of the “UV protected” thermoplastic has cotton gin waste added to the thermoplastic blend at levels ranging from about 1% by weight to about 10% by weight. Generally, the more finely ground cotton gin waste (e.g., a cotton gin waste comminuted by passage through an 80 mesh screen) will have a greater surface area to interact with the other ingredients in the thermoplastic blend.

Alternatively, antioxidant and UV radiation absorbing components of the natural biomass materials are extracted and added to the resin directly, or the extracted components are adsorbed onto the natural biomass materials to increase the concentration of the antioxidant and UV radiation absorbing components available to the thermoplastic whenever the natural biomass materials are added. As the amount of antioxidant and UV radiation absorbing components added to the thermoplastic increases, the amount of extra catalyst needed to initiate and sustain the polymerization process also increases.

Thermoset Products

A plastic in which the polymer molecules are crosslinked is a thermoset plastic. Once crosslinking has occurred, a thermoset plastic does not soften, melt, or flow when heated. However, if the crosslinking occurs within a mold, the shape of the mold will be formed. Thermoset plastics are generally produced by mixing a reinforcing fiber (typically a glass fiber) and a catalyzed thermoset resin.

A number of resins are used in thermoset plastics, a few of the more common ones are unsaturated polyesters, vinyl ester, epoxy, and polyurethane. The reinforcement fibers used in thermoset plastics interact with the resin and reinforce and strengthen the plastic matrix. The type and configuration of the reinforcement fiber is selected, along with certain additives added to the matrix, to specifically produce the desired characteristics for the thermoset product being made. Although, glass is probably the most common reinforcement fiber used, cellulose fibers and other materials are also used to reinforce the matrix.

Natural biomass materials (such as cotton gin waste, wood flour, and nut hull flour) are added to thermoset products to at least partially protect them against UV radiation damage. The natural biomass materials act as reinforcement fibers for the plastic matrix, as well as providing UV protection for the thermoplastic.

A common fabrication process for making thermoset plastics is the so-called “spray-up” in one-sided molds. In a typical open-mold application, the mold is waxed and sprayed with gel coat and, after the gel coat cures, a spray gun is used to concurrently spray reinforcing fiber and a catalyzed resin spray to the mold. For example, if fiberglass is used as some, or all, of the reinforcing fiber then a chopper gun chops roving fiberglass directly into a catalyzed resin spray so that both materials are simultaneously applied to the mold. The product is then cured, cooled and removed from the reusable mold.

Natural biomass materials (such as cotton gin waste, wood flour, and nut hull flour) are used as some, or all, of the reinforcement fibers for the thermoset plastic. A preferred embodiment of the UV protected thermoset plastic has cotton gin waste added to the reinforcing fiber at levels ranging from about 1% by weight to about 10% by weight of the thermoset plastic. Generally, the more finely ground cotton gin waste (e.g., a cotton gin waste comminuted by passage through an 80 mesh screen) will have a greater surface area to interact with the catalyzed resin. The addition of the cotton gin waste to the thermoset plastic has been found to extend the polymerization time of the thermoset plastic, thus requiring additional catalyst be added to start and sustain the polymerization process. For example, experimentation has found that an increase of about 15%-25% volume of catalyst is typically necessary to return the polymerization times to normal when the cotton gin waste is added from about 7.5% by weight to about 10% by weight of the thermoset plastic.

Alternatively, antioxidant and UV radiation absorbing components of the natural biomass materials are extracted and added to the resin directly, or the extracted components are adsorbed onto the natural biomass materials to increase the concentration of the antioxidant and UV radiation absorbing components available to the thermoset plastic whenever the natural biomass materials are added. As the amount of antioxidant and UV radiation absorbing components added to the thermoset plastic increases, the amount of extra catalyst needed to initiate and sustain the polymerization process also increases.

One very effective method of using the UV absorbers and antioxidants of natural biomass materials to protect thermoset products is to apply the UV absorbers and antioxidants to the external surface of the thermoset products. For example, the direct application of the gin waste powder to the surface of a liquefied polymer, before it has polymerized into a solid, allows the polymer to extract and solubilize the UV absorbers and antioxidants found in the gin waste powder at a location where they will be most useful.

One embodiment of a “UV protected” thermoset product has been made and tested for its ability to withstand UV radiation damage. The thermoset product made was a set of storage tanks constructed using a filament winding system which placed polyester resin and glass onto a rotating mandrel. The resin spray gun and the glass chopper were mounted on a carriage that moved parallel to the turning mandrel, allowing the resin and glass to be evenly distributed onto the turning mandrel. Fiber spray equipment was attached to the carriage and arranged so that the cotton gin waste was directed into the resin/glass stream as it was applied to the turning mandrel. The fiber spray equipment could be turned on and off independently of the resin spray gun and glass chopper.

The test tanks were produced with four passes of the carriage, where each pass of the carriage evenly dispensed approximately 1/16 of an inch of material onto the mandrel. During the first carriage pass (layer 1 of the tank), only a 70/30 ratio of resin and glass was dispensed onto the rotating mandrel. The next three carriage passes (layers 2, 3 and 4) distributed 70% resin, 25% glass and 5% cotton gin waste onto the rotating mandrel. Once the four layers were applied, the external surface of the tank was lightly dusted with cotton gin waste while it was still wet. Although the test tanks had a small amount of cotton gin waste as part of the laminate and on the external surface, the cotton gin waste was invisible to the naked eye.

Several test tanks and standard tanks (made exactly in the same manner without the addition of cotton gin waste) were stored side-by-side in a field, where they have been attacked by the elements for about five years. The structural integrity of the standard tanks and the test tanks were assessed and compared after their 5 year exposure to the Texas sun and UV radiation damage.

The standard tanks exhibited substantial UV degradation. Much of the resin in the standard tanks had oxidized so that the resin had separated from the glass fibers, leaving a “hairy” outer surface. The loose glass fibers of the “hairy” outer surface of the standard tanks could be brushed off with your fingers. Furthermore, the standard tanks gave a dull, muted sound when tapped on their surface with a metal object, rather than the “clack” sound given off by a newly manufactured tank. The dull, muted sound indicated a breakdown in the structural integrity of the standard tanks.

The test tanks exhibited no “hairy” surface and no glass fibers could be brushed off with your fingers, indicating that the resin is still firmly attached to the glass fibers. Although the color of the test tanks had diminished slightly over the years, the structural integrity of the test tanks appeared intact as evidenced by the “clack” sound heard when the test tanks were tapped on their surface with a metal object.

Although the test tanks were made with 5% by weight of the cotton gin waste, a preferred embodiment of the “UV protected” thermoset plastic includes approximately 7.5% to 10% by weight of the cotton gin waste. In addition, although the light dusting of the exterior surface of the test tanks apparently assisted in at least partially protecting the test tanks from UV damage, experimentation has found that the application of a more substantial layer of the cotton gin waste to the wet external surface of the thermoset plastic provides even more protection from UV radiation damage. Thus, one method of protecting thermoset plastic products from UV damage is to apply sufficient cotton gin waste to the wet external surface of the thermoset plastic to provide the thermoset plastic with a wood like topical texture and coloring.

Imparting a natural wood like texture to the surface of thermoset products further adds to the attractiveness of outdoor furniture, boat hulls, fence posts, or other structural elements made for outdoor use. Some embodiments of the UV protected thermoset plastic products have a substantial external surface of the cotton gin waste that makes up about 1% to about 10% of the weight of the product and provides a wood like appearance to the product.

It is believed that certain modifications, variations, and changes will be suggested to those skilled in the art in view of the description set forth above. It is therefore to be understood that all such variations, modifications, and changes are believed to fall within the scope of the invention as defined in the appended claims.

What is claimed is:

1. A method for manufacturing polymeric materials at least partially protected against UV damage, the method comprising the steps of:
(a) mixing a polymeric resin and a reinforcement fiber to form a polymeric mixture;
(b) applying a powdered natural biomass material containing UV absorbents and antioxidants to an external surface of the polymeric mixture prior to the solidification of the polymeric mixture; and
(c) allowing the polymeric mixture to polymerize to form a solid polymeric material having an external layer of the natural biomass material.

2. The method of claim 1, wherein the natural biomass material is a cotton gin waste.

3. The method of claim 1, wherein the reinforcement fiber is a cotton gin waste.

4. The method of claim 3, wherein the polymeric mixture comprises from about 7.5% by weight to about 10.0% by weight of the cotton gin waste.

5. The method of claim 1, further comprising the steps of: extracting a mixture of UV absorbents and antioxidants from a powdered cotton gin waste with a liquid monomer and adding the liquid monomer extract to the polymeric resin.

6. The method of claim 5, wherein the liquid monomer extract contains at least one derivative of phthalic acid.

7. The method of claim 1, further comprising the steps of: extracting a mixture of UV absorbents and antioxidants from a powdered cotton gin waste with a liquid monomer and adsorbing the liquid monomer extract to the reinforcement fiber.

8. The method of claim 7, wherein the liquid monomer extract contains at least one derivative of phthalic acid.

9. The method of claim 1, wherein a sufficient quantity of the powdered natural biomass material is applied to the external surface of the liquid polymeric mixture to provide the polymeric material with a wood like appearance.

10. A method for manufacturing thermoplastic products at least partially protected from UV damage whenever the products are exposed to UV radiation, the method comprising the steps of:
(a) blending a polymeric resin, a reinforcement fiber, and a powdered natural biomass material containing UV absorbents and antioxidants to form a liquid polymeric mixture;
(b) introducing the liquid polymeric mixture into a mold having a desired shape;
(c) solidifying the molded polymeric mixture; and
(d) removing the solidified polymeric mixture from the mold.

11. The method of claim 10, wherein the powdered natural biomass material is a cotton gin waste.

12. The method of claim 11, wherein the polymeric mixture comprises from about 7.5% by weight to about 10.0% by weight of the cotton gin waste.

13. A method for manufacturing thermoset plastic products at least partially protected from UV damage whenever the products are exposed to UV radiation, the method comprising the steps of:
(a) mixing a polymeric resin and a reinforcement fiber to form a polymeric mixture;
(b) applying a cotton gin waste to an external surface of the polymeric mixture prior to the solidification of the polymeric mixture, wherein the cotton gin waste contains a mixture of UV absorbers and antioxidants; and
(c) allowing the polymeric mixture to polymerize to form a solid polymeric material having an external layer containing the cotton gin waste.

14. The method of claim 13, wherein a portion of the reinforcement fiber in the polymeric mixture is a finely ground cotton gin waste comminuted by passage through an 80 mesh or greater screen.

15. The method of claim 14, wherein the polymeric mixture comprises from about 7.5% by weight to about 10.0% by weight of the cotton gin waste.

16. The method of claim 13, further comprising the steps of: extracting a mixture of UV absorbents and antioxidants from a powdered cotton gin waste with a liquid monomer and adding the liquid monomer extract to the polymeric resin.

17. The method of claim 16, wherein the liquid monomer extract contains at least one derivative of phthalic acid.

18. The method of claim 13, further comprising the steps of: extracting a mixture of UV absorbents and antioxidants from a powdered cotton gin waste with a liquid monomer and adsorbing the liquid monomer extract to the reinforcement fiber.

19. A thermoset plastic product comprising an external surface having a wood like appearance, wherein the wood like appearance is derived from an external layer of a cotton gin waste.

20. The thermoset plastic product of claim 19, wherein the external layer of the cotton gin waste makes up about 1% to about 10% of the weight of the plastic product.

21. A thermoset plastic composite containing at least two layers of polymerized materials, the composite comprising a first layer of polymerized material containing a cotton gin waste extract including at least one phthalic acid derivative; and an external layer containing cotton gin waste, wherein the external layer has a wood like appearance.
